(19) United States
(12) Patent Application Publication
(10) Pub. No.: US 2012/0252712 A1
(43) Pub. Date: Oct. 4, 2012

(54) Gel-Form Preparations

(75) Inventors: Thomas Albers, Dusseldorf (DE); Bjoern Klotz, Erkrath (DE)

(73) Assignee: Cognis IP management GmbH, Dusseldorf (DE)

(21) Appl. No.: 13/515,349

(22) PCT Filed: Dec. 6, 2010
(86) PCT No.: PCT/EP2010/007403

§ 371 Date: Jun. 12, 2012

(30) Foreign Application Priority Data
Dec. 15, 2009 (EP) 09015484.0

(51) Int. Cl. C11D 17/00

(52) U.S. Cl. 510/191

(57) ABSTRACT

The invention relates to gel-form agents, containing, based on the total weight of the agent, from 45 to 90 wt % of water; from 5 to 35 wt % of emulsifiers and from I to 25 wt % of surfactants as well as optionally further auxiliaries and additives. The gel-form agents have a viscous damping factor Q_{η}, measured at 23° C., in the range of less than 2.50 Pa s and preferably less than 1.80 Pa s. Such gels are suitable as self-clinging sanitary cleaning agents, preferably for cleaning and deodorising toilets.

The present application relates to aqueous, gel-form preparations which comprise certain emulsifiers and optionally further ingredients and which are characterized by their special rheological properties, and to the use of such agents as cleaning agents, in particular for sanitary cleaning.

Sanitary cleaners are understood in general as meaning special cleaning agents which are intended to eliminate deposits of limescale and sometimes urine scale in the sanitary sector, in particular in toilets (cf. Römpp, Chemie Lexikon [Chemistry Lexicon], 9th edition, 1992, p. 3988). Furthermore, agents of this type often also comprise fragrances in order to conceal the typical odors of sanitary facilities, or in order to convey an impression of freshness and cleanness to the user.

Sanitary cleaners therefore comprise customary water-soluble acid for dissolving lime deposits and/or urine scale and regularly a surfactant, which, according to statutory provisions, must be essentially biodegradable, but often leaves a nonbiodegradable residue after use. Suitable water-soluble acids are, for example, organic acids, such as carboxylic acids having 2 to 3 carbon atoms, dicarboxylic acids having 3 to 8 carbon atoms, hydroxycarboxylic acids having 1 to 6 carbon atoms, 1 to 5 hydroxyl groups and 1 to 3 carboxyl groups or mixtures thereof. After use e.g. in the toilet bowl, the sanitary cleaners are flushed into the wastewater system where, under certain circumstances, they have a toxic effect on the microflora present there and, as a result, delay the degradation of the biomass in the wastewater. Despite a good cleaning effect, the known sanitary cleaners are judged increasingly critically on account of the pronounced toxic effect on the microorganisms of the wastewater and the contamination of the wastewater and of the groundwater with incompletely degradable substances and/or with furthermore unacceptable degradation substances.

However, there are also sanitary agents, which are likewise referred to here as sanitary cleaners, which are intended to exhibit less of a cleaning effect and more of a deodorizing effect, and accordingly have a higher proportion of fragrances. These agents are e.g. placed in the toilet in order to release fragrances therein continuously or only upon contact with water.

Sanitary cleaners are usually supplied in the form of solid blocks, or as a liquid formulation which is applied directly to the surface of the sanitary facilities—preferably a toilet—or which is used with the help of a dosing device (e.g. a so-called “WC cage”). For this, the solid or liquid sanitary cleaner is introduced into the dosing device, this dosing device then being positioned such that it comes into contact with the flush water in the toilet in such a way that the cleaner is gradually flushed out of the dosing device and can then develop its effect in the form of a dilute aqueous solution. Supply forms are also available in which the sanitary cleaner is formulated in the form of a viscous gel. These gels have the advantage that they dissolve more rapidly than solid supply forms without resulting in an undesired excessive dose being used. Recently, gel-form products have also been offered which exhibit a certain clinging effect on hard surfaces. Self-clinging gels of this type are intended to suffice without dosing device, which constitutes an improvement from the point of view of the user.

EP 1 086 199 A1 describes gel-form agents which comprise fragrances, surfactants and a clinging promoter, the latter being selected from the group consisting of polyalkoxyalkanes, celluloses, starch, alginates, diurethanes, gelatins, pectins, oleylamines, alkyldimethylamine oxides, stearates, sodium dodecylbenzenesulfonate, agar agar, gum Arabic, carob seed flour, polyacrylate, polyvinyl alcohol and polyvinylpyrrolidone, and the polyalkoxy group of the polyalkoxyalkanes is preferably a polyethoxy, polypropoxy or polybutoxy group or else a mixed polyalkoxy group such as a poly(ethoxypropoxy) group, where polyethoxy groups having between 15 and 55 ethoxy groups, preferably between 25 and 45 and particularly preferably 35+/−5 ethoxy groups, are preferred and the viscosity of the agent is at least 15 000 mPa s.

WO 99/66017 discloses clinging sanitary agents which serve for cleaning and fragrancing and comprise surfactants, water, fragrances and clinging promoters. After direct application to the sanitary object, these sanitary agents are only rinsed off after a relatively large number of flush cycles. EP 1 325 103 A1 describes clinging sanitary agents for smooth surfaces. Further clinging sanitary agents based on block copolymers comprising oligo- or polyalkylene oxides or on aryl ethoxylates or alkyl arylethoxylates as clinging promoters are described in EP 1 318 191 61, and clinging sanitary agents containing bleaches are described in DE 10 2004 056 554 A1.

In practice, however, there continues to be a need to improve clinging sanitary agents of this type in terms of their properties, particularly as regards the ability to cling to hard surfaces. Moreover, the ability of the gels to dissolve in water must be further optimized. Here, it must be taken into consideration that only cold water (i.e. less than 20° C., sometimes as low as 6° C. or 4° C.) is usually used for flushing the toilet, which can lead to delayed dissolution of surfactants or the entire agent. Moreover, the amount of water varies according to user and therefore the sanitary agent must be reliably and controllably dissolved both in the case of large amounts of water and in the case of small amounts of water without adversely affecting the clinging of the gel to the hard surface as a result.

It has been found that gels with certain rheological properties no longer have these disadvantages.

The present application therefore firstly provides a gel-form agent comprising, based on the total weight of the agent,

a) 45 to 90% by weight of water;
b) 5 to 35% by weight of emulsifiers and
c) 1 to 25% by weight of surfactants, and
d) optionally further auxiliaries and additives,
where the gel-form agent has a viscous damping factor Q_{η} (measured at 23° C.) in the range of less than 2.50 Pa s and preferably of less than 1.80 Pa s.

Gels is generally the term used to refer to dimensionally stable, readily deformable disperse systems rich in liquids and gases and made of at least two components which in most cases consist of a solid, colloidally dispersed substance with long or heavily branched particles (e.g. gelatins, silica, montmorillonite, bentonites, polysaccharides, pectins, special polymers, such as e.g. polyacrylates, and other gelling agents often referred to as thickeners) and a liquid (mostly water) as dispersant. In contrast to liquids, gels are not only viscous, but also exhibit elastic properties. According to the embodiment as per the claims, the gels are so-called “ringing gels”, since, in a suitable vessel, they are able to produce, upon external excitation, a vibration frequency which can be perceived by the human ear. The reason for this is the particular elastic properties of the gels according to the invention.

Ringing gels are characterized in Römpp Chemielexikon, online edition, version 3.5 from Jul. 27, 2009, as follows: optically isotropic, transparent gels which, on account of their energy elasticity, are able to induce vibrations in the audible frequency range as a result of mechanical impacts. This property was first found for specific surfactant systems of surfactants, hydrocarbons and water, so-called microemulsion gels (see microemulsion). The audible tone ranges from a low ringing to a high metallic sound and depends on the gel itself, on the size and geometry of the vessel in which the sample is located, and on the fill level. The time constant with which the vibration fades away is in the region of one second for most samples.

Such ringing gels are known and are described for example on the basis of amphoteric surfactants and selected ethylene oxide/propylene oxide copolymers in U.S. Pat. No. 3,925,241. It is notable here that only when selecting certain surfactants or thickeners in selected amounts with one another can the gels be characterized as ringing gels.

For the rheological description of ringing gels, the gel is usually set vibrating at different frequencies (e.g. between 1-100 s⁻¹) by means of a mechanical impulse, and then the resonance curve of the gel is determined. Details relating to ringing gels and their properties can be found in the article by G. Ötter and H. Hoffmann “Ringing Gels and their fascinating Properties”, Colloids and Surfaces, 38, 1989, pp. 225-250, where details relating to the measurement of the resonance frequency can be found in particular on pages 240-245.

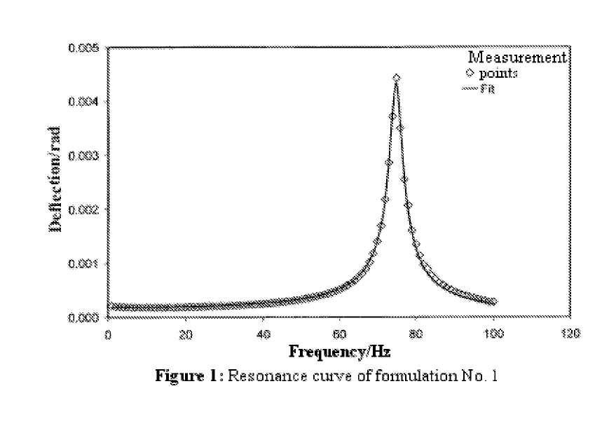

In the present case, this takes place in a commercially available rheometer with plate-plate measurement geometry (see below). FIG. 1 shows a resonance curve for a ringing gel according to the invention.

This is also true for the gels of the present invention. Mathematically, the system can be described as a torsion pendulum, for which the motion equation

I·\ddot{φ}=M₀ cos(ω·t)−k·\dot{φ}−D·φ

applies, where
φ=deflection angle
M₀=amplitude of the torsion torque
D=torsion spring constant
ω=vibration frequency
I=moment of inertia
k=damping constant

The solution to the above differential equation gives, for the deflection A(ω),

$$A ( ω ) = \frac{{M}_{0}}{I \sqrt{{( \frac{D}{I} - {ω}^{2} )}^{2} + \frac{{ω}^{2} {k}^{2}}{{I}^{2}}}}$$

The parameter “k” is determined here by means of a curve fitting to the A(ω) function—compare in this regard also the article cited above by otter and Hoffmann, p. 244 ff. In FIG. 1 of this application, the calculated curve has been compared with values determined experimentally. The measured resonance curves also depend on instrument parameters. The extent of the viscous damping Q_{η} independent of the instrument can be calculated as follows:

$${Q}_{η} = \frac{2 k \cdot h}{π {r}^{4}}$$

where h is the gap height and r is the radius. When using rheometers with plate-plate geometry, it is the gap height between the plates and the radius of the plates.

Q_{η} is a parameter characteristic of ringing gels, a low viscous damping is a prerequisite for the occurrence of the ringing effect. The gels of the present invention exhibit (measured at 23° C.) viscous damping factors in the range of less than 2.50 Pa s and preferably of less than 1.80 Pa s. The lower limit for Q_{η} should preferably be considered to be a value of from 0.01 to 0.05 Pa s or 0.10 Pa s. However, particular preference is given to the range from 2.20 to 0.10 Pa s and preferably 2.00 to 0.20 Pa s, and here in particular the range from 1.80 to 0.25 Pa s, where the range from 1.00 to 0.30 can also be of particularly advantageous importance.

Within the context of the present application, the gels obligatorily comprise, as a basis, water, an emulsifier and a surfactant, and optionally further ingredients, such as emollients and optionally also auxiliaries and additives.

### Emulsifiers

As component b), the gels obligatorily comprise emulsifiers, which can preferably be selected from the group of alkoxylated fatty alcohols and from esters of hydroxycarboxylic acids and preferably the esters of hydroxycarboxylic acids with alkoxylated fatty alcohols.

Alkoxylated fatty alcohols of the general formula (I) conform to the general formula

R-(AO)ₙ—H (I)

in which R is a linear, branched, saturated or unsaturated alkyl or alkenyl radical having 12 to 22 carbon atoms, AO is the groups C₂H₄O and/or C₃H₆O and the index n is a number from 1 to 45, and preferably from 5 to 35.

Typical examples are also the adducts of, on average, 1 to 45, preferably 5 to 40 and in particular 10 to 25 mol onto caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol, and technical-grade mixtures thereof which are produced e.g. during the high-pressure hydrogenation of technical-grade methyl esters based on fats and oils or aldehydes from the Roelen oxo synthesis, and also as monomer fraction during the dimerization of unsaturated fatty alcohols. Preference is given to adducts of 10 to 40 mol of ethylene oxide onto technical-grade fatty alcohols having 12 to 18 carbon atoms, such as, for example, coconut, palm, palm kernel or tallow fatty alcohol.

The range from 6 to 20 parts of AO can also be preferred, as can the range from 5 to 15 or 5 to 10. Preference is further given to alkoxylated fatty alcohols (preferably ethoxylated) which comprise 1 to 10 mol and preferably 2 to 6 mol of alkoxides, preferably only ethylene oxide.

Besides the ethoxylates, it is also possible to use propoxylates or mixed alkoxylates with ethylene oxide and propylene oxide groups (randomized or blockwise distribution).

A second preferred class of emulsifiers are the esters of hydroxycarboxylic acids with fatty alcohols. Hydroxycarboxylic acids are organic acids which contain at least one OH group as well as at least one COOH group in the molecule. They can be in the form of monohydroxycarboxylic acids with one OH group, with two OH groups as dihydroxycarboxylic acids, or with more than two OH groups as polyhydroxycarboxylic acids. Depending on the position of the OH group relative to the COOH group, a distinction is made between alpha-, beta- and gamma-hydroxycarboxylic acids. The acids can occur in saturated form or unsaturated form (example: ricinoleic acid). Known aromatic hydroxycarboxylic acids are salicylic acid (2-hydroxybenzoic acid) and gallic acid (3,4,5-trihydroxybenzoic acid). Hydroxycarboxylic acids preferred in the present invention are alpha-hydroxycarboxylic acids, including in particular tartaric acid, mandelic acid, lactic acid, malic acid, citric acid and salts thereof.

The esters of the hydroxycarboxylic acids with ethoxylated alcohols are known compounds which conform to the formula (II)

R¹-(EO)ₓ—Z (II),

in which R¹ is an alkyl radical having 6 to 22 carbon atoms, preferably having 12 to 14 carbon atoms, X is an integer from 1 to 20, preferably from 2 to 10 and Z is a hydroxycarboxylic acid radical. Hydroxycarboxylic acids preferred in the present invention as radical Z are alpha-hydroxycarboxylic acids, including in particular tartaric acid, mandelic acid, lactic acid, malic acid and citric acid. Compounds of the general formula (II) based on citric acid are particularly preferred here. Mixtures of these ethoxylated hydroxycarboxylic acids are also suitable and preferred.

The gels according to the invention comprise 5 to 35% by weight, preferably 5 to 15% by weight and particularly preferably 5 to 10% by weight, of alpha-hydroxycarboxylic acids and/or salts thereof, based on the total weight of the agent.

As a third class of emulsifiers, the alkoxylated, preferably the ethoxylated, fatty acid polyol partial or complete esters are contemplated. The polyols are understood as meaning in particular glycerol, neopentyl glycol, trimethylolpropane or -ethane, and also oligomers or polymers thereof. The polyols form the basis of esters with fatty acids (linear, branched, saturated or unsaturated) having preferably 6 to 22 carbon atoms. Here, it is possible to use either complete or partial esters, or mixtures thereof, of the polyols. A preferred polyol is glycerol. Suitable fatty acids are those having 6 to 18 and in particular 10 to 16 carbon atoms. These ethoxylation products of partial glycerides are known substances, as are also described, for example, in the German patent specification DE-C 320 24 051 (Henkel). The starting materials used are usually partial glycerides, which are then converted to the desired products by means of customary alkoxylation processes. For this purpose, the starting materials are usually placed in a pressurized reactor, the alkaline catalyst, for example sodium methylate or calcined hydrotalcite, is added, and the desired amount of ethylene oxide is injected. As a rule, on average 1 to 50 and preferably 5 to 20 mol of ethylene oxide per mol of partial glyceride are added on. The temperature here is usually in the range from 110 to 180° C., the autogenous pressure can increase up to 5 bar. After the required amount of ethylene oxide has been added and the pressure has reached a constant value, the mixture is left to after-react for a further ca. 30 min before the autoclave is cooled and decompressed, and the alkaline catalyst is neutralized, for example by adding lactic acid, or filtered off. The addition of catalyst can be omitted in the ethoxylation if an adequate amount of alkali is still present from the preceding transesterification.

The emulsifiers are present in the gels preferably in amounts of from 5 to 35, in particular from 6 to 25 and particularly preferably from 10 to 20% by weight, in each case based on the total weight of the gels.

### Emollients

Within the context of the present technical teaching, suitable emollients are in particular:
(i) dialkyl ethers having 8 to 32 carbon atoms;
(ii) the dialkyl carbonates having 8 to 32 carbon atoms;
(iii) esters of monocarboxylic acids with monohydric fatty alcohols;
(iv) fatty alcohols having 8 to 32 carbon atoms,
(v) or mixtures thereof.

Preferred emollients are to be regarded as the fatty alcohols (iv) and the dialkyl carbonates (ii). Preferred gels therefore comprise either fatty alcohols or dialkyl carbonates, or mixtures of the two substances.

Dialkyl carbonates preferably conform to the general formula (III)

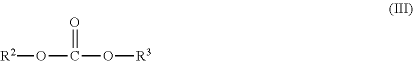

where R² and R³, independently of one another, are linear or branched, saturated or unsaturated alkyl or alkenyl radicals which preferably contain between 1 and 32 carbon atoms. Preferred dialkyl carbonates are those in which one radical is a branched alkyl radical which is derived from oxo alcohols or the so-called Guerbet alcohols. Within the context of this disclosure, dialkyl carbonates in which a radical R² or R³ is an alkyl radical derived from a Guerbet alcohol are termed Guerbet carbonates. These Guerbet carbonates, which are present as clear, colorless to pale-colored liquids even at low temperatures of for example −25° C. and, on account of the branching in the alkyl chain of R² or of R³ and R², are insensitive to hydrolysis under standard conditions. The preparation of these particularly preferred Guerbet carbonates can be carried out in a manner known per se by means of the transesterification of dialkyl carbonates with Guerbet alcohols in the presence of basic catalysts. Preferred Guerbet carbonates have a branched alkyl radical R² having 12 to 28 carbon atoms. In particular, preference is given to symmetrical and asymmetrical Guerbet carbonates in which both R² and R³ are a branched alkyl radical having 12 to 28 carbon atoms, with Guerbet carbonates which a spreading capacity between 300 and 650 mm/10 minutes (measured by the method by U. Zeidler, Fette, Seifen, Anstrichmittel 87, 403 ff. (1985)) are particularly advantageous. Guerbet carbonates with a spreading capacity between 350 and 600 mm/10 minutes have excellent application properties. Examples of particularly preferred symmetrical Guerbet carbonates are those in which R² and R³ are a branched alkyl chain having 16 carbon atoms (spreading capacity 550 mm/10 minutes) or with 20 carbon atoms (spreading capacity 400 mm/10 minutes).

Fatty alcohols are likewise suitable. Fatty alcohols are to be understood as meaning primary aliphatic alcohols of the formula (IV),

R⁴OH (IV)

in which R⁴ is an aliphatic, linear or branched hydrocarbon radical having 6 to 22 carbon atoms and 0 and/or 1, 2 or 3 double bonds. Typical examples are caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol, and technical-grade mixtures thereof which are produced e.g. during the high-pressure hydrogenation of technical-grade methyl esters based on fats and oils or aldehydes from the Roelen oxo synthesis, and also as monomer fraction during the dimerization of unsaturated fatty alcohols. Preference is given to technical-grade fatty alcohols having 12 to 18 carbon atoms, such as, for example, coconut, palm, palm kernel or tallow fatty alcohol.

The emollients are present in the gels preferably in amounts of from 1 to 20% by weight and particularly preferably from 5 to 15% by weight—in each case based on the total weight of the gels.

### Surfactants

The gels comprise surfactants in amounts of from 1 to 25% by weight, which must be structurally different from the emulsifiers b) and specifically of the type of nonionic, anionic, cationic surfactants or of betaines, alone or in combination. Preference is given to anionic and/or nonionic surfactants.

Typical examples of anionic surfactants of the preparations according to the invention are soaps, alkylbenzene sulfonates, alkane sulfonates, olefin sulfonates, alkyl ether sulfonates, glycerol ether sulfonates, α-methyl ester sulfonates, sulfo fatty acids, alkyl sulfates, fatty alcohol ether sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids, such as, for example, acyl lactylates, acyl tartrates, acyl glutamates and acyl aspartates, alkyl oligoglucoside sulfates, protein fatty acid condensates (in particular wheat-based vegetable products) and alkyl (ether) phosphates. If the anionic surfactants contain polyglycol ether chains, these can have a conventional homolog distribution, but preferably have a narrowed homolog distribution.

In the gels according to the invention, however, preference is given to alkyl sulfates, fatty alcohol ether sulfates, alkane sulfonates and alkyl sulfosuccinates, particularly preferably, among these, the alkyl sulfates and/or alkenyl sulfates, and also the alkyl ether sulfates.

Alkyl sulfates and/or alkenyl sulfates, which are also often referred to as fatty alcohol sulfates, are to be understood as meaning the sulfation products of primary alcohols which conform to the formula (II),

R⁵O—SO₃X (V)

in which R⁵ is a linear or branched, aliphatic alkyl and/or alkenyl radical having 6 to 22, preferably 12 to 18, carbon atoms and X is an alkali metal and/or alkaline earth metal, ammonium, alkylammonium, alkanolammonium or glucammonium. Typical examples of alkyl sulfates which can be used for the purposes of the invention are the sulfation products of caproic alcohol, caprylic alcohol, capric alcohol, 2-ethylhexyl alcohol, lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol, and technical-grade mixtures thereof which are obtained by the high-pressure hydrogenation of technical methyl ester fractions or aldehydes from the Roelen oxo synthesis. The sulfation products can preferably be used in the form of their alkali metal salts and in particular their sodium salts. Particular preference is given to alkyl sulfates based on C_{16/18}-tallow fatty alcohols or vegetable fatty alcohols of comparable carbon chain distribution in the form of their sodium salts.

Alkyl ether sulfates (“ether sulfates”) are known anionic surfactants which are produced industrially by SO₃— or chlorosulfonic acid (CSA)-sulfation of fatty alcohol or oxo alcohol polyglycol ethers and subsequent neutralization. Within the context of the invention, suitable ether sulfates are those which conform to the formula (VI),

R⁶O—(CH₂CH₂O)ₘSO₃X (VI)

in which R⁶ is a linear or branched alkyl and/or alkenyl radical having 6 to 22 carbon atoms, m is numbers from 0 or 1 to 10 and X is an alkali metal and/or alkaline earth metal, ammonium, alkylammonium, alkanolammonium or glucammonium. Typical examples are the sulfates of addition products of on average 0 or 1 to 10 and in particular 1 to 5 mol of ethylene oxide on to caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol, and also technical-grade mixtures thereof in the form of their sodium and/or magnesium salts. The ether sulfates here can have either a conventional homolog distribution or a narrowed homolog distribution.

Particular preference is given to the use of ether sulfates based on adducts of on average 1.5 to 2.5 mol of ethylene oxide on to technical-grade C_{12/14}- or C_{12/18}-coconut fatty alcohol fractions in the form of their sodium and/or magnesium salts.

Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers or mixed formals, optionally partially oxidized alk(en)yl oligoglycosides or glucoronic acid derivatives, fatty acid N-alkylglucamides, protein hydrolysates (in particular wheat-based vegetable products), polyol fatty acid esters, sugar esters, sorbitan esters, polysorbates and amine oxides. If the nonionic surfactants contain polyglycol ether chains, these can have a conventional homolog distribution, but preferably have a narrowed homolog distribution.

A preferred class of nonionic surfactants are the alkyl (oligo)glycosides. Alkyl and alkenyl oligoglycosides are known nonionic surfactants which conform to the formula (VII),

R⁷O-[G]ₚ (VII)

in which R⁷ is an alkyl and/or alkenyl radical having 4 to 22 carbon atoms, G is a sugar radical having 5 or 6 carbon atoms and p is numbers from 1 to 10. They can be obtained by the relevant methods of preparative organic chemistry.

The alkyl and/or alkenyl oligoglycosides can be derived from aldoses or ketoses having 5 or 6 carbon atoms, preferably glucose. The preferred alkyl and/or alkenyl oligoglycosides are thus alkyl and/or alkenyl oligoglucosides. The index number p in the general formula (VII) indicates the degree of oligomerization (DP), i.e. the distribution of mono- and oligoglycosides, and is a number between 1 and 10. Whereas p in a given compound must always be an integer and here in particular can assume the values p=1 to 6, the value p for a specific alkyl oligoglycoside is an analytically determined calculated parameter which in most cases is a fraction. Preference is given to using alkyl and/or alkenyl oligoglycosides with an average degree of oligomerization p of from 1.1 to 3.0. From the point of view of application, preference is given to those alkyl and/or alkenyl oligoglycosides whose degree of oligomerization is less than 1.7 and is in particular between 1.2 and 1.4. The alkyl or alkenyl radical R⁷ can be derived from primary alcohols having 4 to 11, preferably 8 to 10, carbon atoms. Typical examples are butanol, caproic alcohol, caprylic alcohol, capric alcohol and undecyl alcohol, and also technical-grade mixtures thereof as are obtained, for example, during the hydrogenation of technical-grade fatty acid methyl esters or in the course of the hydrogenation of aldehydes from the Roelen oxo synthesis. Preference is given to alkyl oligoglucosides of chain length C₈-C₁₀ (DP=1 to 3) which are produced as forerunning during the distillative separation of technical-grade C₈-C₁₈-coconut fatty alcohol and can be contaminated with a fraction of less than 6% by weight of C₁₂-alcohol, and also alkyl oligoglucosides based on technical-grade C_{9/11}-oxo alcohols (DP=1 to 3).

In addition, the alkyl or alkenyl radical R⁷ can also be derived from primary alcohols having 12 to 22, preferably 12 to 14, carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol, and technical-grade mixtures thereof which can be obtained as described above. Preference is given to alkyl oligoglucosides based on hydrogenated C_{12/14}-coconut alcohol with a DP of from 1 to 3.

In a preferred embodiment of the present invention, those gels are selected which comprise alkyl (oligo)glycosides as nonionic surfactants of type c), preferably in combination with at least one emulsifier b) selected from a compound of the general formula (I).

Furthermore, it may be advantageous to select gels which comprise, as emulsifier mixture, partial esters of a hydroxycarboxylic acid with an alkoxylated fatty alcohol together with an alkoxylated fatty alcohol according to the general formula (I), but optionally preferably in combination with an alkyl (oligo)glycoside as nonionic surfactant. It may be preferred that the gels are free from amine oxides.

Typical examples of cationic surfactants are quaternary ammonium compounds and ester quats, in particular quaternized fatty acid trialkanolamine ester salts. Typical examples of amphoteric or zwitterionic surfactants are alkylbetaines, alkylamidobetaines, aminopropionates, aminoglycinates, imidazoliniumbetaines and sulfobetaines. The specified surfactants are exclusively known compounds.

If surfactants are present in the gels, these are used in amounts of from 1 to 25% by weight and preferably from 10 to 20% by weight—in each case based on the total weight of the gels. It is possible to use just one class of surfactants, in which case preferably anionic or nonanionic surfactants are selected, or mixtures of surfactants, either from one class or from two or more classes among one another.

### Hydrocarbons

A further optional constituent of the gels is hydrocarbons. Hydrocarbons is the term used to refer to organic compounds which consist only of carbon and hydrogen. They include both cyclic and acyclic (=aliphatic) compounds. They include both saturated and mono- or polyunsaturated compounds. The hydrocarbons may be linear or branched. Depending on the number of carbon atoms in the hydrocarbon, the hydrocarbons can be divided into odd-numbered hydrocarbons (such as, for example, nonane, undecane, tridecane) or even-numbered hydrocarbons (such as, for example, octane, dodecane, tetradecane). Depending on the type of branching, the hydrocarbons can be divided into linear (=unbranched) or branched hydrocarbons. Saturated, aliphatic hydrocarbons are also referred to as paraffins. In addition, benzenes and diesel oils can also be used. The hydrocarbons that are liquid at room temperature (21° C.) are generally preferred.

Within the context of the present application, paraffins are preferred hydrocarbons. The paraffins are used preferably in amounts of from 1 to 20% by weight and preferably 1 to 10% by weight and in particular from 4 to 8% by weight. In this connection, differing grades of paraffins can be used. However, paraffins that are liquid at room temperature are preferably used. Furthermore, the use of two or more different hydrocarbons, preferably of a paraffin oil and of benzene is preferred.

The paraffins are used preferably in those gels which have anionic surfactants as surfactant component, in which case those formulations which comprise fatty alcohol sulfates may be advantageous here.

Furthermore, preference is given to the use of hydrocarbons in those gel formulations which comprise fatty alcohol ethoxylates of the general formula (I) as emulsifier. Preferred representatives of these alkoxylates then conform to the general formula (I), where n here is in the range from 1 to 10 and preferably 1 to 6 or 1 to 5.

### Auxiliaries and Additives

As well as the components described above, the gels can also comprise further auxiliaries and additives. These include fragrances, biocides, pH regulators, dyes, preservatives, non-aqueous solvents, antifoams, thickeners, and/or disinfectants. Strong acids, in particular inorganic acids, such as HCl or sulfuric acid, are also types of suitable additives. It may, however, also be preferred to dispense entirely with the presence of acids in gel-form agents.

These further optional ingredients are present in total in the gels in amounts of from 0.01 to 25% by weight, preferably 0.1 to 10% by weight, based on the total weight of the gels.

In one particular embodiment of the invention, however, the gels are free from glycerol, 1,3-dihydroxypropane, 1,3- or 1,4-dihydroxybutane, 1,3-dihydroxyisobutane, pentaerythritol selected compound or between 1 and 20% by weight, preferably between 5 and 15% by weight and particularly preferably between 7 and 13% by weight of an aliphatic di-, oligo- or polyhydroxy compound or ethers thereof.

Of particular importance for sanitary cleaning agents of the type proposed here, however, are the fragrances.

### Fragrances

The fragrances, which are present in solid form, but preferably in liquid form, are sometimes complex mixtures of different individual chemical compounds, the so-called odorants.

The odorants can be selected from a very wide variety of chemical classes. A distinction can be made between alkali-stable and less alkali-stable odorants. Alkali-stable odorants are preferred and can be used here, e.g. linalool, geraniol, acetophenone, lilial, geranonitrile, dihydromyrcenol, o-tert-butyl cyclohexyl acetate, anisaldehyde, tetrahydrolinalool, citronellol, cyclohexyl salicylate, phenylethyl alcohol, benzophenone, rose oxide, methyl benzoate, alpha-hexylcinnamaldehyde; the less alkali-stable odorants include vetiveryl acetate, delta-dodecalactone, allyl amyl glycolate, hydroxycitronellal, benzyl acetate, amyl butyrate. Further suitable fragrances are acetophenone, acetyleugenol, elecampane root oil, 1-allyl-2,5-dimethoxy-3,4-(methylenedioxy)benzene, 1-allyl-3-methoxy-4,5-methylenedioxybenzene, 1-allyl-3,4,5-trimethoxybenzene, allyl isothiocyanate (allyl mustard oil), allyl ionone, ethyl formate, alpha-amylcinnamaldehyde, anethole, anisaldehyde, apiol (parsley apiol), alpha-asarone, beta-asarone, ascaridol, atlantone, valerian oil, benzaldehyde, benzylacetone, benzyl alcohol (“phenylmethanol”), bergamotenal, bergamot oil, alpha-bisabolol, bitter almond oil hydrocyanic acid-free, cis-3-hexen-1-ol, D-camphor, citral, alpha-citronellol, costunolide, costus root oil, diallyl sulfide, 3,4-dihydroxybenzaldehyde, 1,4-dimethoxybenzene, elemicin (3,4,5-trimethoxy-1-allylbenzene), geranyl acetate, linalyl acetate, 2-phenylethyl acetate, ethyl formate, ethyl hexanoate, ethyl laurate, eugenol, geranyl acetate, gurjun balsam and gurjun balsam oil, heliotropin (piperonal), hexahydrothymol, 1-hexanol, ethyl hexanoate, cis-3-hexen-1-ol, hexyl alcohol, hydroquinone dimethyl ether, hydroxycitronellal, 4-hydroxy-3-methoxybenzaldehyde, jasmine aldehyde, Canada balsam, ethyl laurate, linalool, linalyl acetate (linayl ester of acetic acid), bay leaf oil, lyral, menthol, menthanone, 3,4-methylenedioxybenzaldehyde, methyl cinnamate, methyl nonyl ketone (2-undecanone), myristicin, nonanal (perlagonaldehyde), alpha-pentylcinnamaldehyde, phenol, 2-phenylethanol, 2-phenylethyl acetate, hydrocinnamyl alcohol, 1-phenyl-1-propanone, propanal, propiophenone (1-phenyl-1-propanone), rotocatechualdehyde (3,4-dihydroxybenzaldehyde), rhodinol, benzyl salicylate, terpinen-4-ol, 2-undecanone see methyl nonyl ketone, vanillin (4-hydroxy-3-methoxybenzaldehyde), verbenol, verbenone, cinnamic acid methyl ester (methyl cinnamate).

The content of fragrances (based on the total weight of the gels) in the gels according to the invention is between 0.01 and 25% by weight, preferably 0.01 to 15% by weight, with contents between 1.0 and 10% by weight and in particular 1.5 to 6% by weight being preferred.

The aqueous gels of the present invention can have a pH in the range from 2 to 12, preferably 3 to 10.5 and in particular from 3.5 to 8, it being possible to adjust the pH by means of bases or acids customary per se. The acids used are preferably hydroxycarboxylic acids, e.g. citric acid.

As a particularly preferred embodiment of the invention, gels are claimed which comprise comprises 10 to 20% by weight of ethoxylated fatty alcohols according to the general formula (I), where n is a number from 25 to 35, 15 to 25% by weight of further emulsifiers b) selected from the group of the partial esters of a hydroxycarboxylic acid with an alkoxylated fatty alcohol and/or of the ethoxylated fatty acid polyol partial or complete ester; optionally 1 to 29% by weight of an emollient according to the above description and, as remainder to 100% by weight, water and optionally auxiliaries and additives.

Preference is likewise given to gels which comprise comprises I) 10 to 20% by weight of ethoxylated fatty alcohols according to the general formula (I), where n is a number from 25 to 35, II) 15 to 25% by weight of further emulsifiers b) selected from the group of the partial esters of a hydroxycarboxylic acid with an alkoxylated fatty alcohol and/or of the ethoxylated fatty acid polyol partial or complete esters; III) optionally 1 to 29% by weight of an emollient according to the description in claim 12, and, as remainder to 100% by weight, water and optionally auxiliaries and additives.

Independently of this, preference is likewise given to those gels which comprise 10 to 25% by weight of an anionic surfactant, preferably a fatty alcohol sulfate; 10 to 20% by weight of an ethoxylated fatty alcohol according to the general formula (I) where n is from 1 to 10; 1 to 10% by weight of an emollient i) to v) according to the above description; 10 to 20% by weight of a hydrocarbon and, as remainder to 100% by weight, water and optionally auxiliaries and additives.

The gels are produced by combining the different constituents, it being possible to use either the hot methods or cold methods known per se. Hot methods are necessary particularly when constituents of the formulation are solid at room temperature; these must then first be melted and then mixed with the other constituents.

The gels according to the invention are particularly suitable as sanitary cleaning agents, preferably as sanitary cleaners which release fragrances for toilets. They are readily self-clinging and do not dissolve too rapidly upon contact with in particular cold water (temperature≦20° C. and in particular 14° C.)

### EXAMPLES

The following gels were produced and tested as to their application properties.

The preparation was carried out by producing a mixture of the ingredients without the perfume at room temperature. The mixture was then heated. The water was to ca. 85° C., and then the perfume was weighed in cold into the hot mixture and stirred in. The water was then added warm and also stirred in.

All gels exhibited ringing. The rheological properties were measured using a Bohlin C-VOR 120 rheometer in the oscillation mode and a 40 mm plate-plate measurement geometry. The gels were stimulated with 1 to 100 s⁻¹, during which a shear stress of 50 Pa and a gap height of 4 mm were chosen. The measurement was carried out at 23° C.

No. 1

| | Amount |
|---|---|
| Ingredients | [% by weight] |
| C16/18 FA 30 EO | 14 |
| Coconut monoglyceride ethoxylated (7 EO) | 20 |
| Dioctyl ether | 5 |
| Perfume oil | 5 |
| Water | 56 |

Viscous damping factor Qη: 1.09 Pa s

No. 2

| | Amount |
|---|---|
| Ingredients | [% by weight] |
| C16/18 FA 30 EO | 14 |
| Coconut monoglyceride ethoxylated (7 EO) | 20 |
| Dioctyl ether | 5 |
| Perfume oil | 10 |
| Water | 51 |

Viscous damping factor Qη: 1.29 Pa s

No. 3

| | Amount |
|---|---|
| Ingredients | [% by weight] |
| C16/18 FA 30 EO | 14 |
| Hydroxycarboxylic acid partial ester of | 20 |
| alkoxylated alcohols plus APG | |
| Dioctyl ether | 5 |
| Perfume oil | 5 |
| Water | 56 |

Viscous damping factor Qη: 2.06 Pa s

No. 4

| | Amount |
|---|---|
| Ingredients | [% by weight] |
| C12-16 fatty alcohol sulfate sodium salt | 20 |
| Oleylcetyl alcohol ethoxylated (10 EO) | 19 |
| Octyldodecyl alcohol *2- | 2 |
| Paraffin oil | 7.5 |
| C12/C13-alkane | 10 |
| Perfume oil | 5 |
| Water | 36.5 |

Viscous damping factor Qη: 0.36 Pa s

No. 5

| | Amount |
|---|---|
| Ingredients | [% by weight] |
| C12-16 fatty alcohol sulfate sodium salt | 20 |
| Oleylcetyl alcohol ethoxylated (5 EO) | 19 |
| Octyldodecyl alcohol *2- | 2 |
| | 17.5 |
| | 41.5 |

Viscous damping factor Qη: 0.55 Pa s

No. 6

| | Amount |
|---|---|
| Ingredients | [% by weight] |
| C16/18 FA 30 EO | 17 |
| Hydroxycarboxylic acid partial ester of | 17 |
| alkoxylated alcohols | |
| Dioctyl ether | 5 |
| Perfume oil | 5 |
| Water | 56 |

Viscous damping factor Qη: 0.99 Pa s

No. 7

| | Amount |
|---|---|
| Ingredients | [% by weight] |
| C16/18 FA 30 EO | 17 |
| Hydroxycarboxylic acid partial ester of | 17 |
| alkoxylated alcohols plus APG | |
| Dioctyl ether | 5 |
| C12-14-fatty alcohol sulfate | 5 |
| triethanolamine salt | |
| Perfume oil | 5 |
| Water | 51 |

Viscous damping factor Qη: 0.55 Pa s

No. 8

| | Amount |
|---|---|
| Ingredients | [% by weight] |
| C16/18 FA 30 EO | 17 |
| Hydroxycarboxylic acid partial ester of | 17 |
| alkoxylated alcohols | |
| Dioctyl ether | 5 |
| C12-14-fatty alcohol sulfate | 5 |
| triethanolamine salt | |
| Perfume oil | 10 |
| Water | 46 |

Viscous damping factor Qη: 1.50 Pa s

### Application Investigations

Application investigations were then undertaken. For this purpose, a flush test was carried out as follows: ca. 5 g of the sample were distributed on a tile and spread to give a uniform clump. A water hose was attached to a stand and narrowed using a hose clamp in order to increase the intensity of the jet. The water jet (temperature of the water ca. 18 to 20° C.) was adjusted such that it lands just above the point, the water tap was opened by ca. 90°. The time was then measured until the gel sample was flushed off.

For sample No. 5, a time of 10:02 minutes was measured, for sample 8 a time of 10:55 min was measured and for sample 8, 19:31 minutes was measured.

This therefore shows that the gels according to the invention take a sufficiently long time in order to be completely flushed away with cold water.

1. A gel-form agent comprising, based on the total weight of the agent,
a) 45 to 90% by weight of water;
b) 5 to 35% by weight of one or more emulsifiers and
c) 1 to 25% by weight of one or more surfactants, and
d) optionally further auxiliaries and additives,
characterized in that the gel-form agent has a viscous damping factor Q_{η}, measured at 23° C., in the range of less than 2.50 Pa s.

2. The agent of claim 1, wherein the damping factor Q_{η}, measured at 23° C., has a value in the range from 2.00 to 0.20 Pa s.

3. The agent of claim 1, wherein the emulsifier b) comprises an alkoxylated fatty alcohol of the general formula (I),
R-(AO)ₙ—H (I)
in which R is a linear, branched, saturated or unsaturated alkyl or alkenyl radical having 12 to 22 carbon atoms, AO is the groups C₂H₄O and/or C₃H₆O, and the index n is a number from 1 to 45.

4. The agent of claim 1, wherein the emulsifier b) comprises a linear, saturated fatty alcohol of the general formula (I) which has been ethoxylated with 1 to 10 mol of ethylene oxide per mol of fatty alcohol.

5. The agent of claim 1, wherein the emulsifier b) comprises a partial ester of a hydroxycarboxylic acid with an alkoxylated fatty alcohol.

6. The agent of claim 1, wherein the emulsifier b) comprises an ethoxylated fatty acid polyol partial or complete ester.

7. The agent of claim 1, wherein the surfactant c) comprises an anionic and/or nonionic surfactant.

8. The agent of claim 1, wherein the surfactant c) comprises an anionic surfactant selected from the group consisting of fatty alcohol sulfates, fatty alcohol sulfonates and fatty alcohol ether sulfates.

9. The agent of claim 7, wherein the surfactant c) comprises a nonionic surfactant selected from the group consisting of alkyl (oligo)glycosides.

10. The agent of claim 1, wherein the emulsifier b) comprises a partial ester of a hydroxycarboxylic acid with an alkoxylated fatty alcohol together with an alkoxylated fatty alcohol according to general formula (I).

11. The agent of claim 1, wherein the emulsifier b) comprises a combination of partial esters of a hydroxycarboxylic acid with an alkoxylated fatty alcohol together with an alkoxylated fatty alcohol according to the general formula (I) and an alkyl (oligo)glycoside.

12. The agent of claim 1, comprising in an amount of from 1 to 20% by weight at least one emollient as an additive selected from the group consisting of:
i) dialkyl ethers having 8 to 32 carbon atoms,
ii) dialkyl carbonates having 8 to 32 carbon atoms,
iii) esters of monocarboxylic acids with monohydric fatty alcohols;
iv) fatty alcohols having 8 to 32 carbon atoms, and
v) mixtures thereof.

13. The agent of claim 1, comprising at least one hydrocarbon in an amount of from 1 to 20% by weight.

14. The agent of claim 1, wherein the hydrocarbon comprises a paraffin oil, benzene, or mixtures thereof.

15. The agent of claim 1, wherein the surfactant c) comprises an anionic surfactant that is a fatty alcohol sulfate, in combination with a hydrocarbon.

16. The agent of claim 1, comprising an additive selected from the group consisting of fragrances, biocides, pH regulators, dyes, preservatives, nonaqueous solvents, antifoams, thickeners, and disinfectants in an amount of from 0.1 to 10% by weight.

17. The agent of claim 1, comprising:
I) 10 to 20% by weight of ethoxylated fatty alcohols according to formula (I), where n is a number from 25 to 25,
II) 15 to 25% by weight of the emulsifiers b) selected from the group consisting of the partial esters of a hydroxycarboxylic acid with an alkoxylated fatty alcohol and/or the ethoxylated fatty acid polyol partial or complete esters;
III) optionally 1 to 29% by weight of an emollient selected from the group consisting of:
i) dialkyl ethers having 8 to 32 carbon atoms,
ii) dialkyl carbonates having 8 to 32 carbon atoms,
iii) esters of monocarboxylic acids with monohydric fatty alcohols;
iv) fatty alcohols having 8 to 32 carbon atoms, and
v) mixtures thereof;
and, as remainder to 100% by weight, water.

18. The agent of claim 1, comprising:
I) 10 to 25% by weight of an anionic surfactant that is a fatty alcohol sulfate;
II) 10 to 20% by weight of an ethoxylated fatty alcohol according to the general formula (I) where n is from 1 to 10;
III) 1 to 10% by weight of an emollient selected from the group consisting of:
i) dialkyl ethers having 8 to 32 carbon atoms,
ii) dialkyl carbonates having 8 to 32 carbon atoms,
iii) esters of monocarboxylic acids with monohydric fatty alcohols;
iv) fatty alcohols having 8 to 32 carbon atoms, and
v) mixtures thereof;
IV) 10 to 20% by weight of a hydrocarbon and
as remainder to 100% by weight, water.
